(19) United States
(12) Patent Application Publication
(10) Pub. No.: US 2015/0269464 A1
(43) Pub. Date: Sep. 24, 2015

(54) Image Forming Apparatus

(71) Applicant: Funai Electric Co., Ltd., Osaka (JP)

(72) Inventors: Michihito ATSUMI, Osaka (JP); Ryosuke TERADA, Osaka (JP)

(21) Appl. No.: 14/661,160

(22) Filed: Mar. 18, 2015

(30) Foreign Application Priority Data
Mar. 19, 2014 (JP) 2014-057012
Mar. 19, 2014 (JP) 2014-057014
Jan. 26, 2015 (JP) 2015-012310

(51) Int. Cl. G06K 15/00; G06F 3/12

(52) U.S. Cl. CPC G06K 15/4095; G06F 3/1285; G06F 3/1238; G06F 3/1274; G06F 3/1263

(57) ABSTRACT

An image forming apparatus comprising: a storage that stores data, first identification information, and specified disclosure information, the first identification information and the specified disclosure information being associated with the data; a reader that reads second identification information; a controller that compares the first identification information with the second identification information based on the specified disclosure information; and an image forming unit that forms an image based on a result of the comparison.

### BACKGROUND

1. Technical Field

An aspect of the present invention relates to an image forming apparatus configured to receive image data from a plurality of terminals connected to a network such as a LAN, and form images on media.

2. Related Art

Recently, a networked printing apparatus has become prevalent that performs printing on media such as paper based on image data of photographs, characters, graphics, and the like, transmitted from a plurality of computer terminals connected to a network such as a LAN (local area network). In the networked printing apparatus, a plurality of users can use a single printing apparatus to print image data transmitted from their own terminals.

Here, printing a highly confidential document on the networked printing apparatus involves the risk that someone may accidentally view the document. For example, JP2005-1155A discloses an image forming apparatus with a function of protecting confidentiality of a printed material.

In the conventional configurations including the configuration disclosed in JP2005-1155A, a predetermined authentication is performed in a printing apparatus at the start of printing, and printing is performed if the authentication is successful. No authentication is performed in accordance with a file type. Moreover, after the printing is started, no further authentication is performed until the printing is completed. Accordingly, once the authentication is performed before the start of printing, the printing is continued even when a user leaves the printing apparatus. This sometimes causes a highly confidential printed document to remain uncollected on the printing apparatus.

### SUMMARY

The present invention has been made to solve the problems described above, and an object of the present invention is to provide an image forming apparatus capable of further improvement of the function of protecting a highly confidential printed material.

To solve the above-described problems, the present invention adopts the following means. The description given below contains the reference signs on the drawings being placed in parentheses, merely for facilitation of understanding of the invention and not for limiting elements of the present invention. The elements should be construed as widely as within the technical purview of those skilled in the art.

A first aspect of the present invention is an image forming apparatus (printing apparatus 10) including:

a storage (memory 120) that stores data (image data), first identification information (user identification information), and specified disclosure information (file type), the first identification information (user identification information) and the specified disclosure information (file type) being associated with the data;

a reader (IC card reader 130, fingerprint detector 150, or biometric information detector 160) that reads second identification information (user identification information, biometric information, or the like);

a controller (CPU 100) that compares the first identification information with the second identification information based on the specified disclosure information; and

an image forming unit (printing unit 140) that forms an image based on a result of the comparison.

The image forming apparatus having the above-described configuration is able to perform a comparison and/or verification using identification information before starting image formation based on data that is classified as a specified file. This can avoid a situation where, for example, a highly confidential printed material remains uncollected on the image forming apparatus.

A second aspect of the present invention is the above-described image forming apparatus, wherein

the storage (memory 120) stores an image-forming order that is according to the order in which the data is received,

the controller (CPU 100) changes the image-forming order based on the specified disclosure information,

the image forming unit (printing unit 140) forms an image based on the changed image-forming order.

The image forming apparatus having the above-described configuration is able to, for example, prioritize printing of data associated with predetermined specified disclosure information such as highly confidential data. This can facilitate avoidance of a situation where a highly confidential printed material remains uncollected on the image forming apparatus.

A third aspect of the present invention is the above-described image forming apparatus, wherein

upon succeeding in the comparison, the controller (CPU 100) raises the image-forming order of the data.

The image forming apparatus having the above-described configuration is able to prioritize image formation of data for which identification information has been successfully compared. This can avoid a situation where a user whose identification information has been compared and/or verified has to wait for a long time before printing of his/her data is started.

A fourth aspect of the present invention is the above-described image forming apparatus, wherein

if image formation of another data is in execution, the controller (CPU 100) raises the image-forming order of the data so as to cause image formation of the data to be performed next to the image formation of said another data.

The image forming apparatus having the above-described configuration is able to prioritize image formation of data for which identification information has been successfully compared over image formation of other data such that the image formation of the data for which the identification information has been successfully compared comes immediately after image formation of data that is in execution at the time of the comparison. This can avoid a situation where a user whose identification information has been compared and/or verified has to wait for a long time before image formation of his/her data is started.

A fifth aspect of the present invention is the above-described image forming apparatus,

further including a display unit (display unit 180) that displays a time to completion of the image formation of said another data during the image formation of said another data.

The image forming apparatus having the above-described configuration enables the user to recognize a time to completion of image formation of another data. This can enhance convenience to the user.

A sixth aspect of the present invention is the above-described image forming apparatus, wherein

if there is data associated with first identification information that is identical with the first identification information of the data, the controller (CPU 100) collectively raises image-forming orders of the plurality of data associated with the same first identification information.

The image forming apparatus having the above-described configuration is able to, for example, successively form images of data of the same user. This can enhance convenience to the user.

A seventh aspect of the present invention is the above-described image forming apparatus, wherein

upon failing in the comparison, the controller prioritizes image formation of another data over image formation of the data.

The image forming apparatus having the above-described configuration is able to skip data for which identification information is not successfully compared and/or verified, and prioritize image formation of image data received subsequent to the skipped image data. This can prevent occurrence of stagnation of image formation in the image forming apparatus.

An eighth aspect of the present invention is the above-described image forming apparatus, wherein

upon failing in the comparison and not yet succeeding in the comparison after a predetermined period of time elapses since the data is received, the controller (CPU 100) deletes the data stored in the storage.

The image forming apparatus having the above-described configuration is able to delete, from the storage, data for which identification information is not successfully compared and/or verified. This can prevent data from being left in the storage. Accordingly, the storage can be prevented from storing an excessive amount of data. Leakage of highly confidential data can be also prevented.

A ninth aspect of the present invention is the above-described image forming apparatus,

further including an input unit (input unit 170) that obtains fourth identification information (for example, an inputted password) based on an input operation detected, wherein

the storage (memory 120) further stores third identification information (user identification information concerning the password) associated with the data,

if the comparison is failed and a comparison of the third identification information with the fourth identification information against each other is successful, the controller (CPU 100) considers the comparison as successful and executes the same processing as executed upon succeeding in the comparison.

The image forming apparatus having the above-described configuration is able to perform image formation according to a comparison with use of another identification information, even when the comparison of identification information is failed due to, for example, damage of an IC card.

A tenth aspect of the present invention is the above-described image forming apparatus, wherein

the controller (CPU 100) prioritizes image formation of another data over image formation of the data until the reader reads the second identification information.

The image forming apparatus having the above-described configuration is able to skip data for which identification information is not successfully compared and/or verified, and prioritize image formation of image data received subsequent to the skipped image data. This can prevent occurrence of stagnation of image formation in the image forming apparatus.

An eleventh aspect of the present invention is the above-described image forming apparatus, wherein

if the second identification information is not yet read by the reader after a predetermined period of time elapses since the data is received, the controller (CPU 100) deletes the data stored in the storage.

The image forming apparatus having the above-described configuration is able to delete, from the storage, remaining data for which identification information has not been compared and/or verified. This can prevent the remaining data from being left in the storage. Accordingly, the storage can be prevented from storing an excessive amount of data. Leakage of highly confidential data can be also prevented.

A twelfth aspect of the present invention is the above-described image forming apparatus,

further including an input unit (input unit 170) that obtains fourth identification information (for example, an inputted password) based on an input operation detected, wherein

the storage (memory 120) further stores third identification information (user identification information concerning the password) associated with the data,

if the second identification information is not read by the reader and a comparison of the third identification information with the fourth identification information is successful, the controller (CPU 100) considers the comparison as successful and executes the same processing as executed upon succeeding in the comparison.

The image forming apparatus having the above-described configuration is able to form an image according to a comparison with use of another identification information, even when the comparison of identification information is disabled due to, for example, a loss of an IC card.

A thirteenth aspect of the present invention is the above-described image forming apparatus, wherein

if, after image formation of the data is started, a predetermined period of time elapses but the image formation is continued, the controller (CPU 100) re-executes the comparison of the first identification information with the second identification information.

In the image forming apparatus having the above-described configuration, after the image formation is started, the comparison of the identification information is re-executed at a predetermined timing. This makes it possible to temporarily stop image formation if, after the image formation is started, the user leaves the image forming apparatus so that the comparison of the identification information can no longer be performed. This can avoid a situation where, for example, a highly confidential printed material remains uncollected on the image forming apparatus.

A fourteenth aspect of the present invention is the above-described image forming apparatus, wherein

the first identification information and the second identification information are biometric information.

The image forming apparatus having the above-described configuration is able to perform the comparison by using biometric information such as fingerprint information, palm-print information, or vein information as the identification information. This can enhance security.

A fifteenth aspect of the present invention is the above-described image forming apparatus, wherein

the first identification information and the second identification information are fingerprint information.

The image forming apparatus having the above-described configuration enables the comparison to be performed by using generally-adopted fingerprint information as the identification information. This can enhance security with a relatively simple configuration and at a low cost.

Another aspect (second aspect) of the present invention is an image forming apparatus (printing apparatus 10) including:

a storage (memory 120) that stores received image data and first identification information associated with the image data;

a reader (IC card reader 130) that reads second identification information recorded on a medium (IC card); and

an image formation processor (CPU 100) that verifies whether or not the first identification information and the second identification information are identical, and if they are identical, performs image formation (printing) on a medium (paper) based on the image data, wherein

the verification, by the image formation processor, of whether or not the first identification information and the second identification information are identical is performed at the start of image formation and at intermittent timings after the start of the image formation.

In the above-described configuration, a process of the verification of the identification information is executed at intermittent timings after the start of the image formation. This makes it possible to temporarily stop image formation if, after the image formation is started, the user leaves the image forming apparatus so that the verification of the identification information can no longer be performed at intermittent timings. This can avoid a situation where, for example, a highly confidential printed material remains uncollected on the image forming apparatus.

Still another aspect of the present invention is the above-described image forming apparatus (second aspect), wherein

the storage stores a plurality of the image data and the first identification information each associated with each of the plurality of the image data, the storing being made according to the order in which the data is received,

upon verifying that the first identification information associated with one image data is identical with the second identification information, the image formation processor performs image formation (printing) on a medium (paper) based on the one image data earlier than image formation of another image data received before the one image data.

The above-described configuration can avoid a situation where a user whose identification information has been verified has to wait for a long time before image formation (printing) of his/her image data is started.

Still another aspect of the present invention is the above-described image forming apparatus (second aspect), wherein

the storage stores a plurality of the image data and the first identification information each associated with each of the plurality of the image data, the storing being made according to the order in which the data is received,

upon failing to verify that the first identification information associated with one image data is identical with the second identification information, the image formation processor performs image formation (printing) on a medium (paper) based on another image data received subsequent to the one image data, earlier than image formation based on the one image data.

The above-described configuration is able to skip image data for which identification information is not verified, and prioritize image formation (printing) of image data received subsequent to the skipped image data. This can prevent stagnation of image formation.

Still another aspect of the present invention is the above-described image forming apparatus (second aspect), wherein

the storage stores a plurality of the image data and the first identification information each associated with each of the plurality of the image data, the storing being made according to the order in which the data is received,

if the first identification information associated with one image data is identical with the first identification information associated with another image data received subsequent to the one image data; the image formation processor performs image formation (printing) on a medium (paper) based on said another image data after completing image formation on a medium based on the one image data, under the condition that, after the second identification information once becomes non-checkable and then becomes checkable again, it is verified that the first identification information associated with said another image data is identical with the second identification information.

In the above-described configuration, to perform image formation of a plurality of highly confidential image data, it is necessary that a medium (IC card) including second identification information is once put off when image formation of one image data is completed and image formation of next (another) image data is started. Accordingly, in a case where the user keeps the medium (IC card) left on the card reader after the identification information of the one image data is verified, image formation of the next image data following the one image data can be prohibited. This can enhance protection of highly confidential documents.

Still another aspect of the present invention is the above-described image forming apparatus (second aspect), wherein

the storage stores a plurality of the image data and the first identification information each associated with each of the plurality of the image data, the storing being made according to the order in which the data is received,

upon verifying that the first identification information associated with one image data is identical with the second identification information, the image formation processor stops currently performed image formation of another image data received prior to the one image data, and performs image formation (printing) on a medium (paper) based on the one image data.

The above-described configuration is able to stop currently performed image formation of image data, and perform by interruption image formation of image data for which identification information is verified. This can avoid a situation where a user whose identification information has been verified has to wait for a long time before image formation (printing) of his/her image data is started.

Still another aspect (third aspect) of the present invention is an image forming apparatus (printing apparatus 10) including:

a storage (memory 120) that stores received image data and identification information (user identification information) associated with the image data;

a biometric information detector (fingerprint detector 150 or biometric information detector 160) that detects first biometric information (an entire fingerprint, veins, or the like) and second biometric information (a part of a fingerprint, a palm print, or the like); and

an image formation processor (CPU 100) that starts image formation (printing) on a medium (paper) based on the image data if a pre-registered relationship is established between the identification information and the first biometric information (an entire fingerprint, veins, or the like),

the image formation processor determining to continue image formation on a medium based on the image data at intermittent timings after the image formation is started, under the condition that a pre-registered relationship is established between the identification information and the second biometric information (a part of a fingerprint, a palm print, or the like).

The above-described configuration performs the authentication based on the biometric information at intermittent timings after the image formation is started. Accordingly, if, after the image formation is started, the user leaves the image forming apparatus so that the authentication based on the biometric information can no longer be performed at intermittent timings, the image formation (printing) on a medium can be stopped temporarily. This can avoid a situation where a highly confidential printed material remains uncollected on the image forming apparatus.

Moreover, since the second biometric information is used for the authentication based on the biometric information performed at intermittent timings, printing can be continued without the need of stop even when, for example, a user's finger placed on the fingerprint detector (biometric information detector) is displaced. Here, it may be acceptable that, for example, a vein authentication, which provides a high-accuracy authentication, is performed at the start of image formation while a fingerprint authentication or palm-print authentication, which provides a less accuracy, is performed at intermittent timings. This can avoid a situation where printing is stopped due to an accidental authentication failure at a time of determining whether or not to continue image formation.

Still another aspect of the present invention is the above-described image forming apparatus (third aspect), wherein

the first biometric information is fingerprint information,

the second biometric information is information of a part of the fingerprint.

The above-described configuration can be achieved by using a prevalent fingerprint authentication apparatus that is relatively inexpensive.

Still another aspect of the present invention is the above-described image forming apparatus (third aspect), wherein

the storage stores a plurality of the image data and the identification information each associated with each of the plurality of the image data,

upon authenticating that a pre-registered relationship is established between the identification information associated with one image data and the first biometric information, the image formation processor performs image formation on a medium based on the one image data earlier than image formation based on another image data received prior to the one image data.

The above-described configuration can avoid a situation where a user who has been authenticated based on the biometric information has to wait for a long time before image formation (printing) of his/her image data is started.

Still another aspect of the present invention is the above-described image forming apparatus (third aspect), wherein

the storage stores a plurality of the image data and the identification information each associated with each of the plurality of the image data,

upon failing to authenticate that a pre-registered relationship is established between the identification information associated with one image data and the first biometric information, the image formation processor performs image formation on a medium based on another image data received subsequent to the one image data, earlier than image formation based on the one image data.

The above-described configuration is able to skip image data for which the authentication based on biometric information is not successfully performed, and prioritize image formation (printing) of image data received subsequent to the skipped image data. This can prevent stagnation of image formation.

### BRIEF DESCRIPTION OF THE DRAWINGS

FIG. 1 shows a configuration of a printer system;

FIG. 2 is a flowchart depicting a printing process according to an embodiment 1;

FIG. 3 is a flowchart depicting a printing process according to an embodiment 2;

FIGS. 4A and 4B show a specific example of a printing order change process;

FIGS. 5A and 5B show a specific example of the printing order change process;

FIG. 6 is a flowchart depicting a printing process according to an embodiment 3;

FIG. 7 is a flowchart depicting a printing process according to an embodiment 4;

FIG. 8 shows a configuration of the printer system;

FIG. 9 is a flowchart depicting a printing process according to an embodiment 5;

FIGS. 10A and 10B shows a specific example of a fingerprint authentication;

FIG. 11 is a flowchart depicting a printing process according to an embodiment 6;

FIG. 12 shows a configuration of the printer system;

FIG. 13 is a flowchart depicting a printing process according to an embodiment 7;

FIG. 14 shows a configuration of the printer system;

FIG. 15 is a flowchart depicting a printing process according to an embodiment 9; and

FIG. 16 shows a configuration of the printer system.

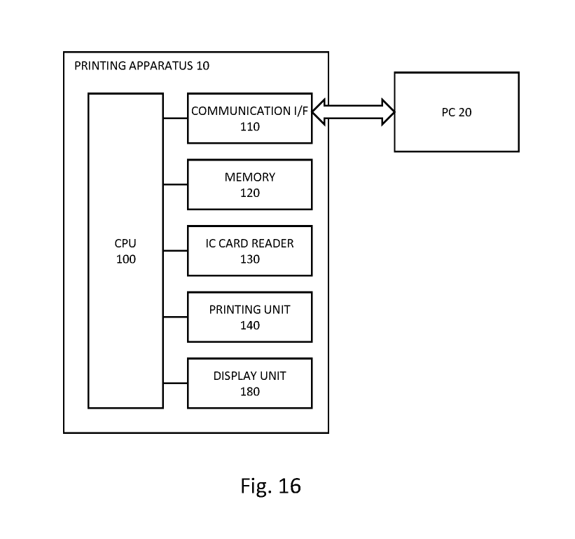

### DESCRIPTION OF EXEMPLARY EMBODIMENTS

With reference to the drawings, a specific description of some embodiments of the present invention will be given based on the following configurations. It should be noted that the embodiments described below are merely illustrative examples of the present invention and not to be construed as limiting the technical scope of the present invention. In the drawings, the same elements are denoted by the same reference signs, and repetitive description may be omitted.

1. Embodiment 1
(1) Configuration of Printer System
(2) Specific Example of Printing Process
(3) Features of Image Forming Apparatus

2. Embodiment 2

3. Embodiment 3

4. Embodiment 4

5. Embodiment 5

6. Embodiment 6

7. Embodiment 7

8. Embodiment 8

9. Embodiment 9

10. Embodiment 10

11. Supplementary Remarks

### 1. Embodiment 1

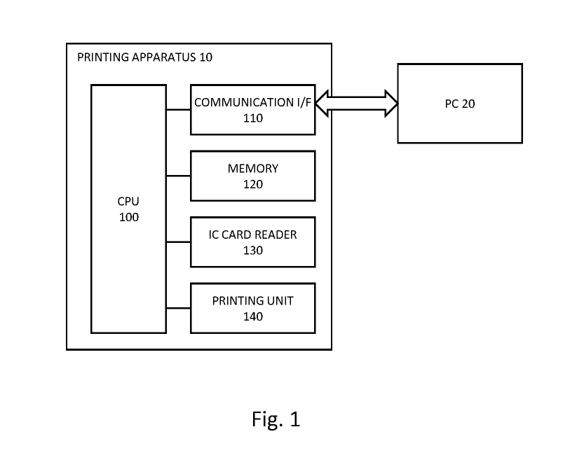

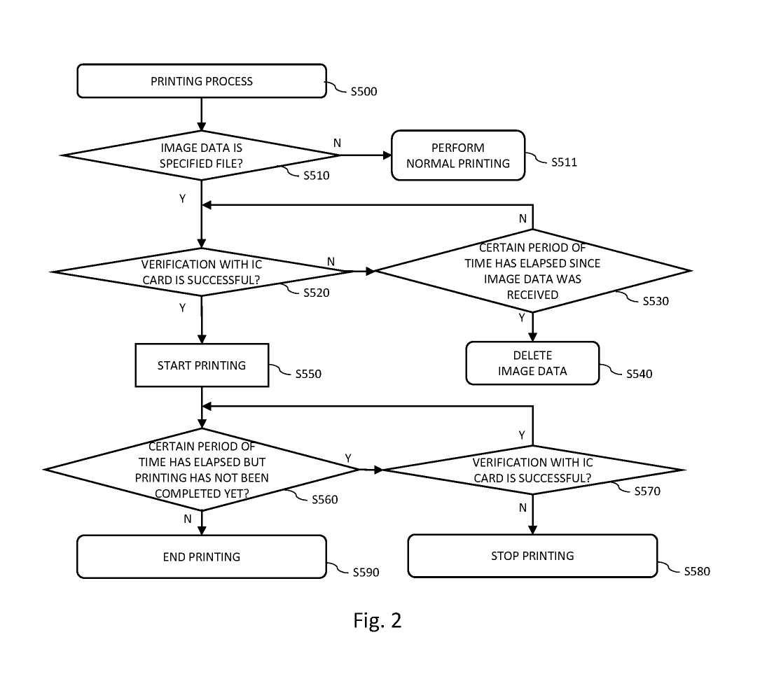

First, an embodiment 1 of the present invention will be described with reference to FIGS. 1 and 2.

### (1) Exemplary Configuration of Printer System

FIG. 1 shows a configuration of a printer system according to this embodiment. As shown in FIG. 1, the printer system of this embodiment includes a printing apparatus 10 and a PC 20. The PC 20 is a so-called computer terminal which is generally known, but may be any apparatus as long as it is able to transmit image data to be printed to the printing apparatus 10. Thus, the PC 20 may be a smartphone, a tablet device, or the like. Here, forming a predetermined image on a recording medium such as paper with ink or the like is called printing.

(PC 20)

The PC 20 transmits, to the printing apparatus 10, image data to be printed, and user identification information and a file type associated with the image data. The user identification information, which is identification information registered individually for each user, is information that enables identification of a user seeking to print data. The user identification information may be determined by a user ID that the user has used when logging in to the PC 20. In a case where the number of users who use each PC 20 is one, the user identification information may be identification information registered individually for each PC 20. The file type is information that enables identification of whether the image data is a normal file or a specified file. Whether the type is the normal file or the specified file is determined by the user of the PC 20. In one example, the specified file is a highly confidential file (data) while the normal file is less confidential file (data) than the specified file.

(Printing Apparatus 10)

The printing apparatus 10 includes a CPU 100, a communication I/F (communication interface) 110, a memory 120, an IC card reader 130, and a printing unit 140.

(Communication I/F 110)

The communication I/F 110 receives the image data and the user identification information and file type associated with the image data transmitted from the PC 20, and outputs them to the CPU 100.

(Memory 120)

The memory 120, in response to a command from the CPU 100, stores the image data and the user identification information and file type associated with the image data, and in response to a request from the CPU 100, outputs the stored image data, user identification information, and file type to the CPU 100. The memory 120 stores the image data and the user identification information and file type associated with the image data. This storing is, in principle, made according to the order in which the data is received by the printing apparatus 10. The image data, the user identification information, and the file type that are stored in the memory 120 are subjected to printing according to the order in which the data is received by the printing apparatus 10. This printing order can be changed by the CPU 100.

(IC Card Reader 130)

The IC card reader 130 reads user identification information recorded on an IC card located near the IC card reader 130. The IC card reader 130 outputs the user identification information that has been read to the CPU 100.

(Printing unit 140)

The printing unit 140 includes an ink head, a photosensitive drum, or the like, that is generally provided in an ink-jet printer, a laser printer, or the like. The printing unit 140 prints an image on a medium such as paper based on image data that is received together with a print command from the CPU 100. Also, in accordance with a command from the CPU 100, the printing unit 140 stops printing of image data in the middle of the printing and starts printing another image data.

(CPU 100)

The CPU 100 executes various processes in accordance with a program recorded on the memory 120 or an internal memory of the CPU 100. The CPU 100 stores, into the memory 120, the image data and the user identification information and file type associated with the image data that are received from the communication I/F 110. Based on the user identification information received from the IC card reader 130, the CPU 100 verifies whether or not the same information is contained in user identification information associated with image data of a specified file stored in the memory 120. In addition, the CPU 100 outputs image data together with a print command to the printing unit 140, to cause the printing unit 140 to perform printing on a medium such as paper. A specific printing process including the process executed by the CPU 100 will be described later.

### (2) Specific Example of Printing Process

Next, a specific example of the printing process will be described with reference to FIG. 2.

(S500)

FIG. 2 is a flowchart depicting a specific example of the printing process performed in the printing apparatus 10. The communication I/F 110 receives, from the PC 20, image data and user identification information and file type associated with the image data, and then the communication I/F 110 outputs, to the CPU 100, the image data, the user identification information, and the file type. The CPU 100 stores, into the memory 120, the image data, the user identification information, and the file type in a set, as image data that is last in the printing order. Then, the CPU 100 starts the printing process (S500).

(S510 to S511)

The CPU 100 determines whether or not, among the received image data, user identification information, and file type, the file type is a specified file (S510). If the file type associated with the image data is not a specified file but a normal file (S510:N), normal printing is performed without verifying the user identification information (S511).

(S520 to S540)

If the file type associated with the image data is a specified file (S510:Y), the CPU 100 determines whether or not the user identification information of this image data is successfully verified with an IC card (S520). The verification is made based on whether or not the IC card reader 130 determines that the user identification information associated with the image data and the user identification information registered on the IC card that has been read by the IC card reader 130 are identical. If the user identification information are not identical or the IC card reader 130 fails to recognize the IC card itself (S520:N), the CPU 100 determines whether or not a certain period of time (for example, one hour) has elapsed since the image data was received (S530). If the certain period of time has not elapsed since the image data was received (S530:N), the verification process with the IC card (S520) is repeated. If the certain period of time has elapsed since the image data was received (S530:Y), the image data and the user identification information and file type associated with the image data are deleted from the memory 120 (S540).

(S550)

If, as a result of the verification in S520, the user identification information associated with the image data of the specified file is identical with the user identification information of the IC card read by the IC card reader 130 (S520:Y), the CPU 100 transmits the image data for which the user identification information is successfully verified to the printing unit 140, and issues a print command (S550).

(S560, S590)

The CPU 100 monitors whether or not a certain period of time (for example, 30 seconds) has elapsed since the printing was started based on the above-described process (S560). If the printing is completed within the certain period of time (S560:N), the printing process ends (S590).

(S570 to S580)

If the certain period of time (for example, 30 seconds) has elapsed but the printing has not been completed yet (S560:Y), the verification with the IC card is performed again. More specifically, in the same manner as the process of S520, whether or not the user identification information associated with the image data currently printed is identical with the user identification information of the IC card read by the IC card reader 130 again is verified (S570). If the user identification information are not identical or the IC card reader 130 fails to recognize the IC card itself (S570:N), the CPU 100 commands the printing unit 140 to stop the printing (S580). If, as a result of the verification, it is determined that the user identification information are identical (S570:Y), the printing of the image data is continued, and whether or not another certain period of time has elapsed is determined (S560).

The image data of the specified file subjected to the stopped printing may be kept stored in the memory 120. The process of verifying the user identification information with the IC card is repeated (S520 to S530), and if the verification is successful, the printing of the image data of the specified file may be restarted (S550).

### (3) Features of Image Forming Apparatus

In the image forming apparatus having the above-described configuration, the verification process (the process of S570) is executed at intermittent timings (for example, every 30 seconds) after the image formation is started. Therefore, if the user leaves the image forming apparatus after the image formation is started, the image formation on a medium can be stopped (the process of S580). This can avoid a situation where, for example, a highly confidential printed material remains uncollected on the image forming apparatus.

The image forming apparatus (printing apparatus 10) of this embodiment deletes image data (the process of S540), if the certain period of time has elapsed since the image data was received. This can avoid a situation where highly confidential image data (specified file) remains stored in the memory 120 of the printing apparatus 10.

In the image forming apparatus (printing apparatus 10) of this embodiment, the verification of the user identification information is required not for all files but for the specified files alone. This can avoid cumbersomeness which would be caused if the verification of the user identification information is required also for relatively less confidential image data.

### 2. Embodiment 2

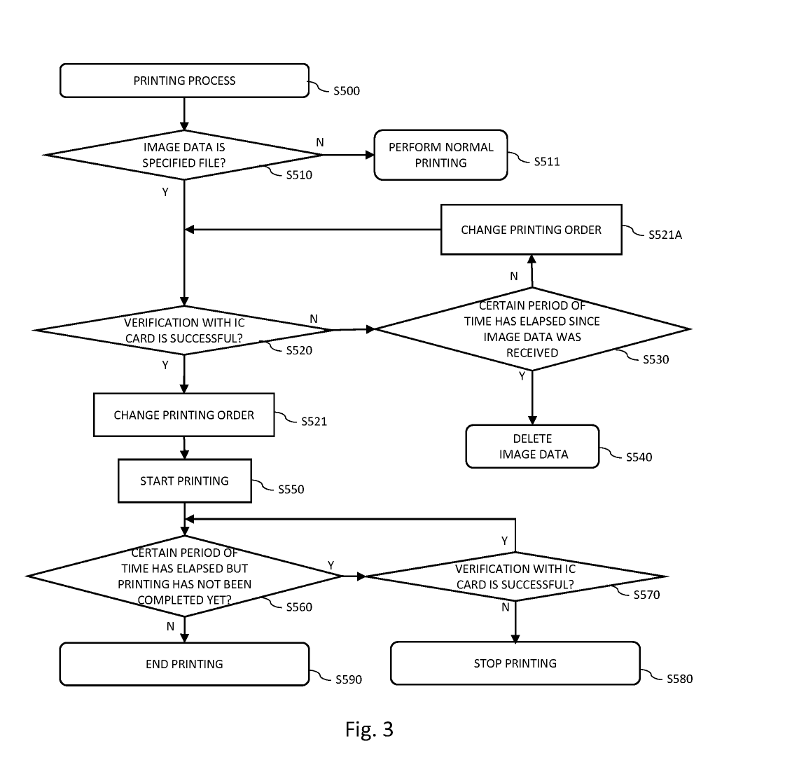

Next, an embodiment 2 of the present invention will be described with reference to FIGS. 3 to 5. This embodiment is different from the embodiment 1 in that a process of S521 is additionally provided between S520 and S550 and that a process of S521A is additionally performed in returning from S530 to S520. In the following, a specific description will be given only of differences from the embodiment 1, and functions and processes similar to those of the embodiment 1 are not described.

(S521)

As shown in FIG. 3, if it is determined in S520 that the user identification information associated with the image data of the specified file is identical with the user identification information of the IC card read by the IC card reader 130 (S520:Y), the CPU 100 executes a printing order change process for changing the printing orders of the image data stored in the memory 120 (S521).

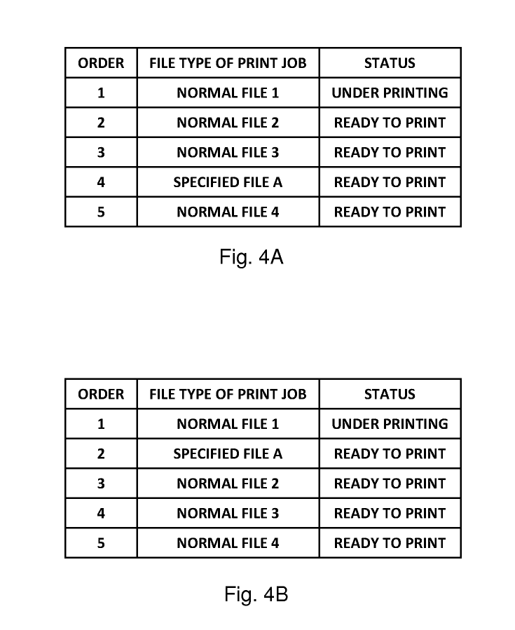

FIG. 4 is a conceptual diagram showing a list of print jobs stored in the memory 120. The print job indicates information concerning image data to be printed, and contains image data and a file type and user identification information associated with the image data. As shown in FIG. 4, the memory 120 stores image data according to the printing order, and also stores the file type and the user identification information (not shown) associated with the image data.

FIG. 4(a) shows a storage state of the memory 120 immediately before the CPU 100 executes the printing order change process (S521). As shown in FIG. 4(a), image data having the printing order 1 is a normal file that is currently printed, image data having the printing orders 2, 3, and 5 are normal files that are ready to print, and image data having the printing order 4 is a specified file that is ready to print. If, in S520, the user identification information of the specified file having the printing order 4 is verified (S520:Y), the CPU 100 executes the printing order change process for prioritizing printing of this image data for which the user identification information has been verified (S521). To be more specific, the CPU 100 executes the printing order change process such that this image data is printed next to the currently printed image data.

FIG. 4(b) shows a storage state of the memory 120 immediately after the CPU 100 executes the printing order change process (S521). As shown in FIG. 4(b), the printing order of the image data of the specified file for which the user identification information has been verified is raised from 4 to 2, with lowering of the printing orders of the image data from 2 and 3 to 3 and 4, respectively.

In a case where a plurality of image data of the specified files associated with the same user identification information are stored in the memory 120, the printing orders of these image data may be collectively raised.

(S521A)

Referring to FIG. 3, if, in S530, a certain period of time (for example, one hour) has not elapsed since the image data was received, the CPU 100 executes the printing order change process for changing the printing orders of the image data stored in the memory 120 (S521A) prior to verifying the IC card again.

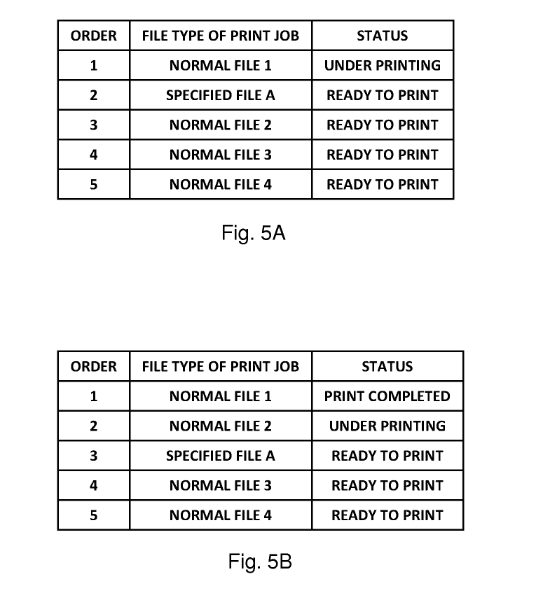

FIG. 5 is a conceptual diagram showing a list of print jobs stored in the memory 120. FIG. 5(a) shows a storage state of the memory 120 immediately before the CPU 100 executes the printing order change process (S521A). As shown in FIG. 5(a), image data having the printing order 1 is a normal file that is currently printed, image data having the printing order 2 is a specified file that is ready to print, and image data having the printing orders 3 to 5 are normal files that are ready to print. In the process of S520, the user identification information associated with the image data having the printing order 2 that is the specified file has not yet been successfully verified (S520:N). Therefore, the CPU 100 executes the printing order change process for prioritizing printing of the image data having the printing order 3 that is the normal file over printing of the image data having the printing order 2 that is the specified file (S521A).

FIG. 5(b) shows a storage state of the memory 120 immediately after the CPU 100 executes the printing order change process (S521A). As shown in FIG. 5(b), the printing order of the image data that is the specified file for which the user identification information has not yet been successfully verified is lowered from 2 to 3 while the printing order of the image data that is the normal file is raised from 3 to 2. It may be conceivable that the process of S521A is executed only at a timing of completion of printing of the currently printed image data.

The printing apparatus 10 (image forming apparatus) having such a configuration can avoid a situation where the user whose identification information has been verified has to wait for a long time before image formation (printing) of his/her image data is started.

The above-described configuration is also able to skip image data (image data of a specified file) for which identification information is not verified, and prioritize image formation (printing) of image data (image data of a normal file) received subsequent to the skipped image data. This can prevent stagnation of image formation.

### 3. Embodiment 3

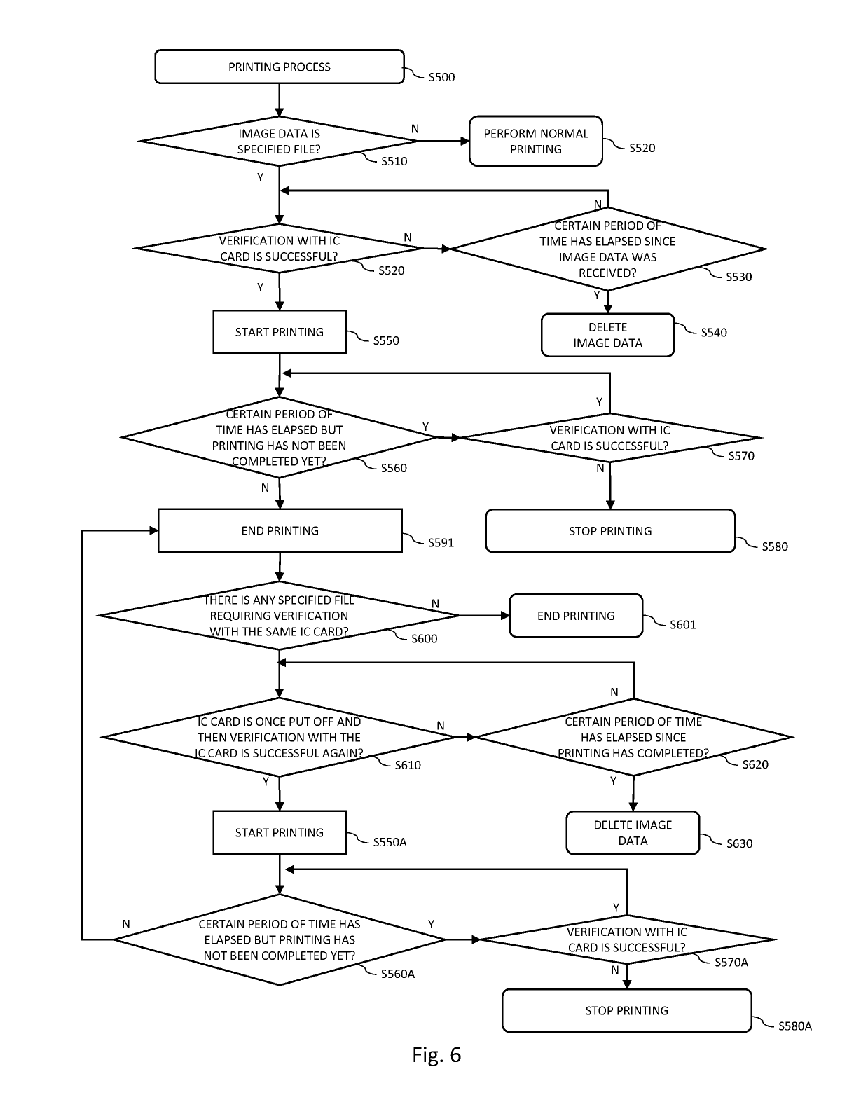

Next, an embodiment 3 of the present invention will be described with reference to FIG. 6. This embodiment is different from the embodiment 1 in that an additional process is provided after the printing ends (S590). In the following, a specific description will be given only of differences from the embodiment 1, and functions and processes similar to those of the embodiment 1 are not described.

(S591 to S601)

After the user identification information is successfully verified (S520) and the printing process is completed (S591), the CPU 100 determines whether or not image data stored in the memory 120 includes any image data of a specified file having user identification information identical with the user identification information of the image data for which the printing process is completed (S600). If image data stored in the memory 120 does not include any image data of a specified file having user identification information identical with the user identification information of the image data for which the printing process is completed (S600:N), the current printing is terminated, and next printing is performed as necessary (S601).

(S610)

If image data stored in the memory 120 includes any image data of a specified file having user identification information identical with the user identification information of the image data for which the printing process is completed (S600:Y), the CPU 100 determines whether or not the IC card reader 130 is successful in re-verifying the IC card that records the user identification information verified in the previous process (S520 and S560) after the IC card has once become non-verifiable (unreadable) (S610). That is, the user has to take the IC card once away from a IC card reading unit of the IC card reader 130 and then waves the IC card over the IC card reading unit.

(S620 to S630)

If, in S610, the IC card that records the user identification information verified in the previous process by the IC card reader 130 still remains verifiable or is now non-verifiable (S610:N), whether or not a certain period of time (for example, one hour) has elapsed since the printing was completed is determined (S620). If the certain period of time has not elapsed since the printing was completed (S620:N), the process of S610 is repeated. If the certain period of time has elapsed since the printing was completed (S620:Y), the image data of the specified file for which the user identification information has not been successfully verified is deleted from the memory 120 (S630).

(S550A)

If, in S610, the IC card that records the user identification information verified in the previous process by the IC card reader 130 once becomes non-verifiable (unreadable) and then is successfully verified again (S610:Y), the CPU 100 transmits the image data for which the user identification information has been successfully verified to the printing unit 140, and issues a print command (S550A).

(S560A to S580A)

The process of S560A to S580A is the same as the process of S560 to S580 of the embodiment 1, but the process returns to S591 after completion of the printing (S560A:N).

In the printing apparatus 10 (image forming apparatus) having the above-described configuration, to perform image formation of a plurality of highly confidential image data (image data of specified files), it is necessary that a medium (IC card) including second identification information is once put off when image formation of first image data is completed and image formation of next (another) image data is started. Therefore, in a case where the user keeps the medium left on the card reader after the identification information of the first image data is verified, image formation of the next image data following the first image data can be prohibited. This can enhance protection of highly confidential documents.

### 4. Embodiment 4

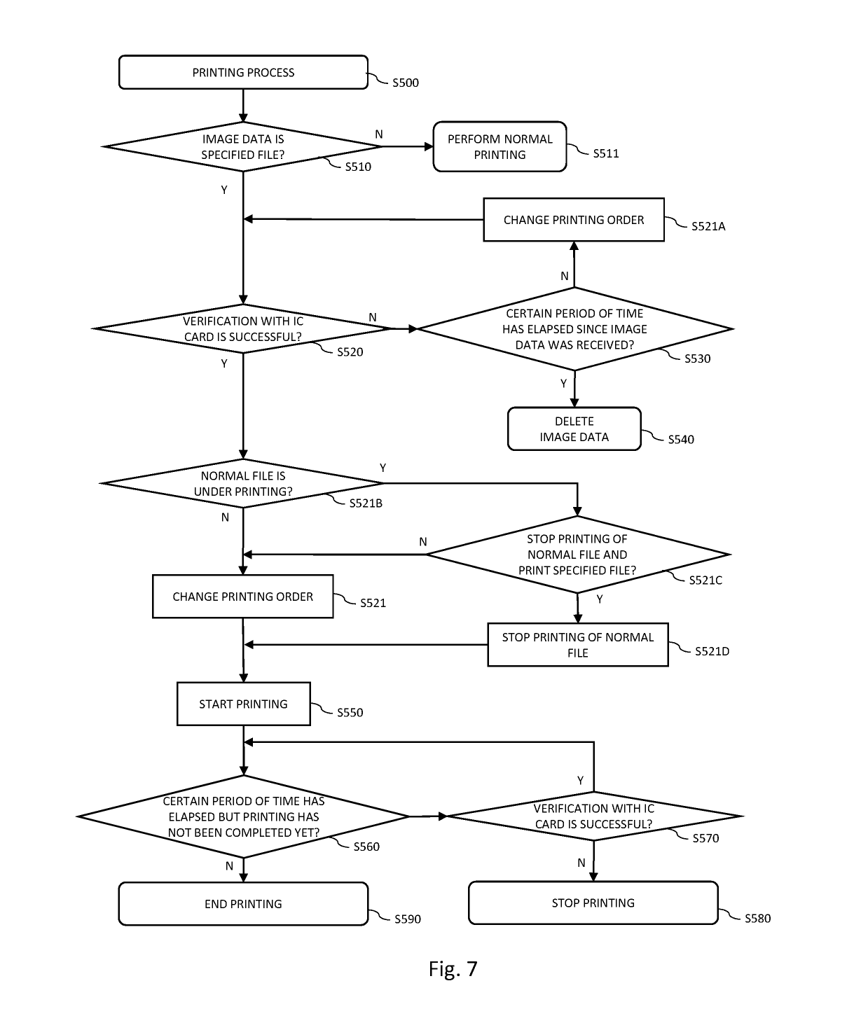

Next, an embodiment 4 of the present invention will be described with reference to FIG. 7. This embodiment is different from the embodiment 2 in that a process of S521B to S521D is additionally provided between S520 and S521. In the following, a specific description will be given only of differences from the embodiment 2, and functions and processes similar to those of the embodiment 2 are not described.

(S521B)

As shown in FIG. 7, if, in S520, the user identification information associated with the image data of the specified file is identical with the user identification information of the IC card read by the IC card reader 130 (S520:Y), the CPU 100 determines whether or not the printing unit 140 is performing printing of a normal file (S521B). If the printing unit 140 is not performing printing of a normal file (S521B:N), the CPU 100 executes the printing order change process of S521 (S521). Subsequent processes are the same as those of the embodiment 2.

(S521C to S521D)

If the printing unit 140 is performing printing of a normal file (S521B:Y), the CPU 100 temporarily stops the printing of the normal file, and inquires to the user whether or not to perform, by interruption, printing of the image data of the specified file for which the user identification information has been successfully verified (S521C). This inquiry is made through displaying on a display screen (not shown) of the printing apparatus 10. If the user has inputted an operation of performing, by interruption, printing of the image data of the specified file for which the user identification information has been successfully verified (S521C:Y), the CPU 100 commands the printing unit 140 to stop the printing of the currently printed normal file (S521D) and perform, by interruption, printing of the image data of the specified file for which the user identification information has been successfully verified (S550). At this time, the image data of the normal file for which printing is stopped is kept stored in the memory 120. The printing of the normal file is restarted upon completion of the printing of the image data of the specified file printed by interruption (S590) or upon stopping of the printing due to a failure in the authentication of the user identification information with the IC card (S580).

If the user has inputted an operation of not performing, by interruption, printing of the image data of the specified file for which the user identification information has been successfully verified (S521C:N), the CPU 100 executes the printing order change process of S521 (S521).

The printing apparatus 10 (image forming apparatus) having the above-described configuration is able to stop image formation of image data (image data of a normal file) in the middle of the image formation, and perform image formation (printing) of image data (image data of a specified file) for which identification information has been successfully verified by interruption. This can avoid a situation where the user whose identification information has been verified has to wait for a long time before image formation (printing) of his/her image data is started.

### 5. Embodiment 5

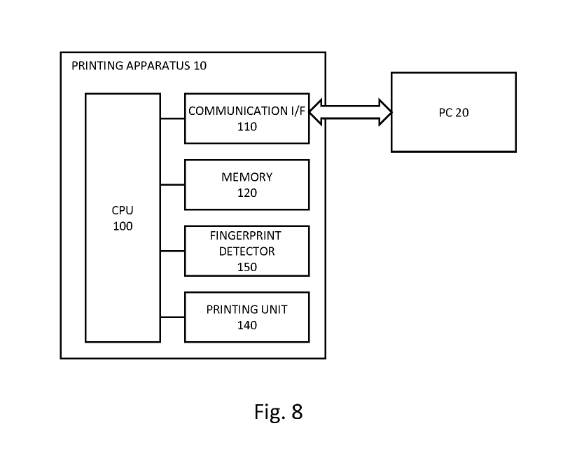

An embodiment 5 of the present invention will be described with reference to FIGS. 8 to 10. A printing apparatus of this embodiment, which includes a fingerprint detector 150 instead of the IC card reader 130, is different from that of the embodiment 1 in how to verify the identification information. In the following, this difference will be mainly described, and functions and processes similar to those of the embodiment 1 are not described.

FIG. 8 shows a configuration of a printer system according to this embodiment. As shown in FIG. 8, the printer system of this embodiment includes a printing apparatus 10 and a PC 20.

(Printing Apparatus 10)

The printing apparatus 10 includes a CPU 100, a communication I/F (communication interface) 110, a memory 120, a fingerprint detector 150, and a printing unit 140.

(Fingerprint Detector 150)

The fingerprint detector 150 detects a fingerprint of a finger placed by the user, and outputs image information of the detected user's fingerprint to the CPU 100.

(CPU 100) The CPU 100 identifies user information based on the image information of the fingerprint received from the fingerprint detector 150, and compares the identified user information against user identification information associated with image data of a specified file stored in the memory 120, to thereby execute a fingerprint authentication.

The CPU 100 pre-stores, in an internal memory or the memory 120, fingerprint authentication information that is usable for identification of user information based on image information of a fingerprint. The fingerprint authentication information can be registered by user's operation. The CPU 100 executes the fingerprint authentication by determining by comparison whether or not the received image information of the fingerprint is coincident with the image information of the fingerprint that is pre-registered as the fingerprint authentication information. The fingerprint authentication information includes information of not one finger but a plurality of fingers.

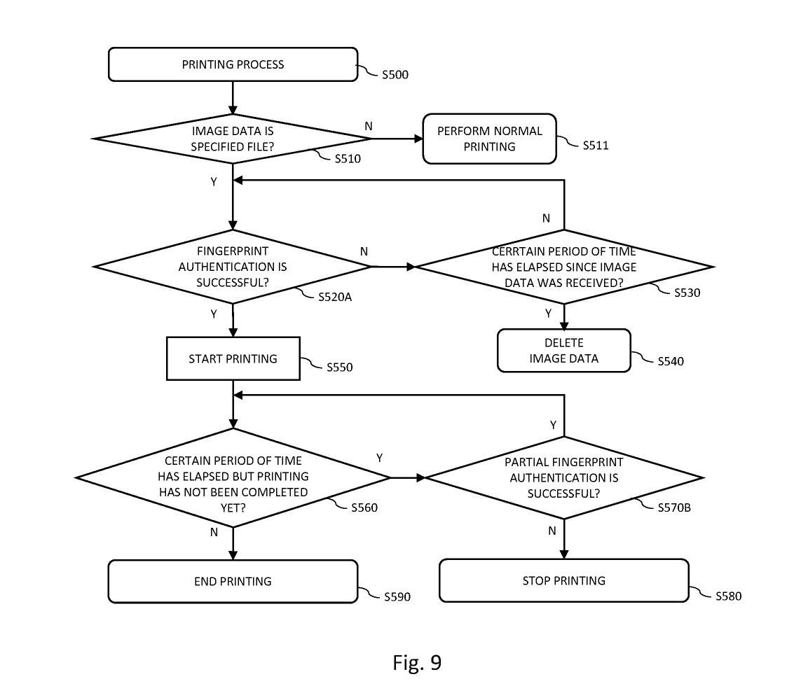

Next, a specific example of the printing process will be described with reference to FIG. 9. FIG. 9 is a flowchart depicting a specific example of the printing process performed in the printing apparatus 10. This process is different from the process (see FIG. 2) of the embodiment 1 in that S520A and S570B replace S520 and S570, respectively. The other parts of the process are the same. In the following, the differences will be described.

(S520A to S540)

If the file type associated with the image data is a specified file (S510:Y), the CPU 100 determines whether or not a fingerprint authentication for this image data is successful (S520A). To execute this fingerprint authentication, a display that prompts a fingerprint authentication is presented on a screen of the PC 20 in response to a command given from the printing apparatus 10, and then the CPU 100 determines by comparison whether or not user information contained in fingerprint authentication information corresponding to a fingerprint of a placed finger that is detected by the fingerprint detector 150 is coincident with user identification information associated with the specified file. If the user information corresponding to the fingerprint is not coincident with the user identification information, that is, if the fingerprint authentication is failed, or if the fingerprint detector 150 is not able to detect a fingerprint (S520A:N); the CPU 100 determines whether or not a certain period of time (for example, one hour) has elapsed since the image data was received (S530). If the certain period of time has not elapsed since the image data was received (S530:N), the fingerprint authentication process (S520A) is repeated. If the certain period of time has elapsed since the image data was received (S530:Y), the image data and the user identification information and file type associated with the image data are deleted from the memory 120 (S540).

(S570B to S580)

If, after printing is started (S550), a certain period of time (for example, 30 seconds) has elapsed but the printing has not been completed yet (S560:Y), the CPU 100 executes a partial fingerprint authentication (S570B). To execute the partial fingerprint authentication, the fingerprint detector 150 determines by comparison whether or not user information contained in fingerprint authentication information corresponding to a fingerprint of a placed finger is coincident with the user identification information associated with the specified file. If the user information corresponding to the fingerprint is not coincident with the user identification information, that is, if the fingerprint authentication is failed, or if the fingerprint detector 150 is not able to detect a fingerprint (S570B:N); the CPU 100 commands the printing unit 140 to stop the printing (S580). If the partial fingerprint authentication is successful (S570B:Y), the CPU 100 continues the printing of the image data, and determines whether or not another certain period of time has elapsed (S560).

(Fingerprint Authentication)

A more specific description will be given of the fingerprint authentication (an overall fingerprint authentication) and the partial fingerprint authentication.

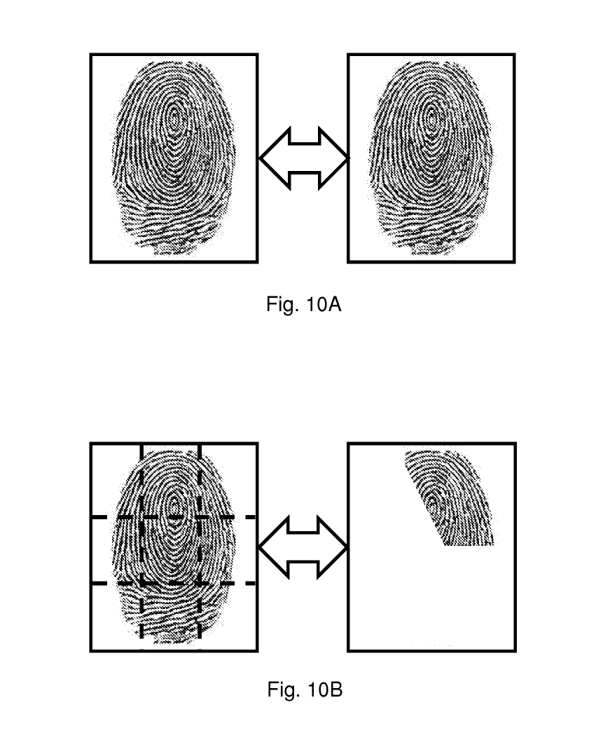

FIG. 10 shows a specific example of the fingerprint authentication. FIG. 10(a) shows the overall fingerprint authentication, and FIG. 10(b) shows the partial fingerprint authentication.

As shown in FIG. 10(a), the overall fingerprint authentication is implemented by the CPU 100 comparing image information of an entire fingerprint of a finger that the user places on the fingerprint detector 150 against image information of an entire fingerprint that is pre-registered. The pre-registered image information of the fingerprint serves as fingerprint authentication information associated with user information. This enables identification of the user placing his/her finger on the fingerprint detector 150.

As shown in FIG. 10(b), the partial fingerprint authentication is implemented by the CPU 100 comparing image information of a part of a fingerprint of a finger that the user places on the fingerprint detector 150 against image information of a part of a fingerprint that is pre-registered. As shown in the left figure of FIG. 10(b), the pre-registered image information of the fingerprint is divided into nine segments when stored. The CPU 100 determines that the partial fingerprint authentication is successful if comparison of image information is successful in at least one of the segments of the divided image (see S570B). Therefore, even when the user's finger placed on the fingerprint detector 150 is somewhat out of position, the CPU 100 determines that the partial fingerprint authentication is successful.

The above-described overall fingerprint authentication and partial fingerprint authentication are non-limiting examples. Various methods are applicable. For example, it may be acceptable that a condition for succeeding in the overall fingerprint authentication is that image comparison is successful in ten characteristic parts of the fingerprint while a condition for succeeding in the partial fingerprint authentication is that image comparison is successful in two parts of the fingerprint.

In the printing apparatus 10 (image forming apparatus) having the above-described configuration, the authentication based on the fingerprint is performed at intermittent timings after the image formation is started. Therefore, if, after the image formation is started, the user leaves the image forming apparatus so that the authentication based on the fingerprint can no longer be performed at intermittent timings, the image formation (printing) on a medium can be stopped. This can avoid a situation where a highly confidential printed material remains uncollected on the image forming apparatus.

The printing apparatus 10 (image forming apparatus) having the above-described configuration can be achieved by using a relatively inexpensive fingerprint authentication apparatus.

Since the fingerprint authentication performed at intermittent timings is the partial fingerprint authentication, printing can be continued without the need of stop even when, for example, the user's finger placed on the fingerprint detector 150 is displaced.

In the image forming apparatus (printing apparatus 10) of this embodiment, if the certain period of time has elapsed since image data was received, the image data is deleted (the process of S540). This can avoid a situation where highly confidential image data (specified file) remains stored in the memory 120 of the printing apparatus 10.

In the image forming apparatus (printing apparatus 10) of this embodiment, the fingerprint authentication is required not for all files but for the specified files alone. This can avoid cumbersomeness which would be caused if the fingerprint authentication is required also for relatively less confidential image data.

### 6. Embodiment 6

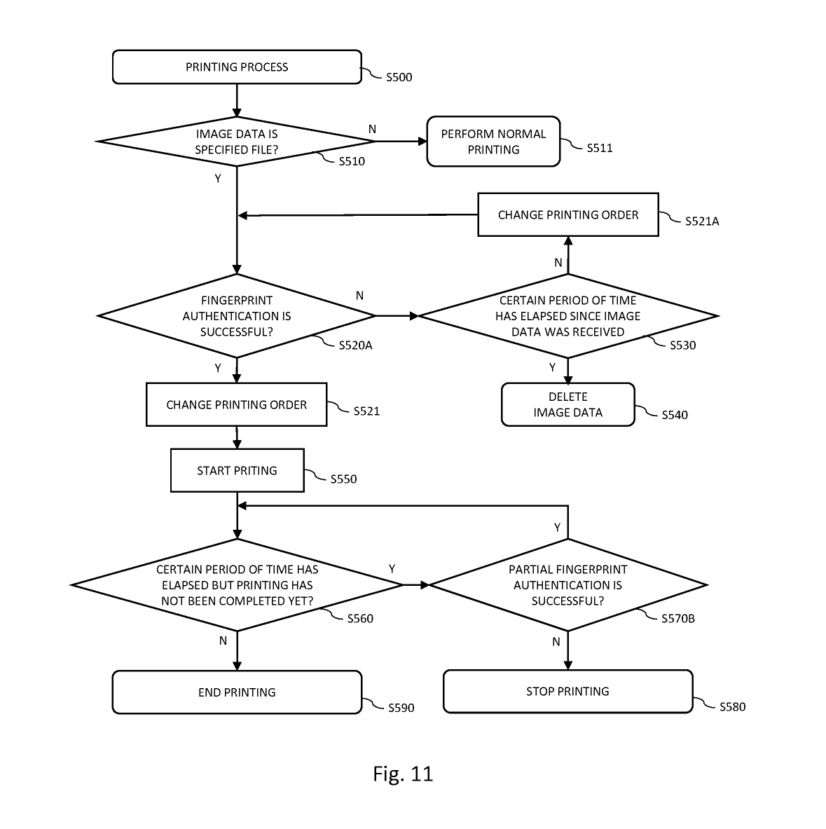

Next, an embodiment 6 of the present invention will be described with reference to FIG. 11 as well as FIGS. 4 and 5. This embodiment is a combination of the embodiment 5 and the embodiment 2, and different from the embodiment 5 in that a process of S521 is additionally provided between S520A and S550 and that a process of S521A is additionally performed in returning from S530 to S520A. In the following, a specific description will be given of differences from the embodiments 5 and 2, and functions and processes similar to those of the embodiments 5 and 2 are not described.

(S521)

Referring to FIG. 11, if, in S520A, user identification information associated with image data of a specified file is coincident with user information contained in fingerprint authentication information corresponding to a fingerprint read by the fingerprint detector 150, that is, if the fingerprint authentication is successful (S520A:Y); the CPU 100 executes a printing order change process for changing the printing orders of the image data stored in the memory 120 (S521). The printing order change process is the same as the already described one (see FIGS. 4 and 5).

(S521A)

If, in 5530, a certain period of time (for example, one hour) has not elapsed since the image data was received, the CPU 100 executes the printing order change process for changing the printing orders of the image data stored in the memory 120 (S521A) prior to executing the fingerprint authentication (the process of S520A) again, as shown in FIG. 11. The printing order change process is the same as the already described one (see FIGS. 4 and 5).

The printing apparatus 10 (image forming apparatus) having the above-described configuration can avoid a situation where the user who has been authenticated based on biometric information (fingerprint) has to wait for a long time before image formation (printing) of his/her image data is started.

The printing apparatus 10 (image forming apparatus) having the above-described configuration is able to skip image data (image data of a specified file) for which the fingerprint authentication is not performed, and prioritize image formation (printing) of image data (image data of a normal file) received subsequent to the skipped image data. This can prevent stagnation of image formation.

### 7. Embodiment 7

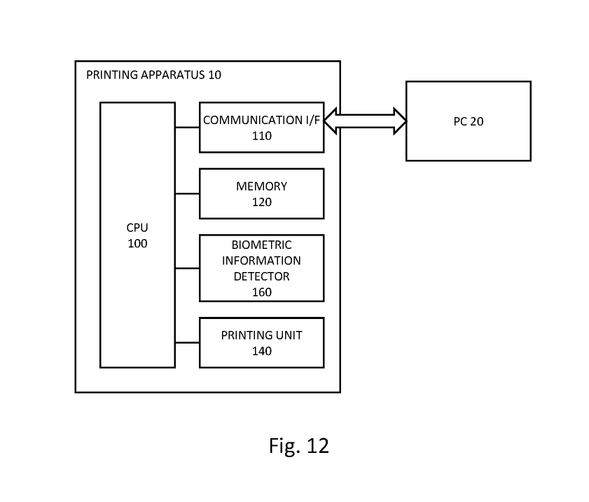

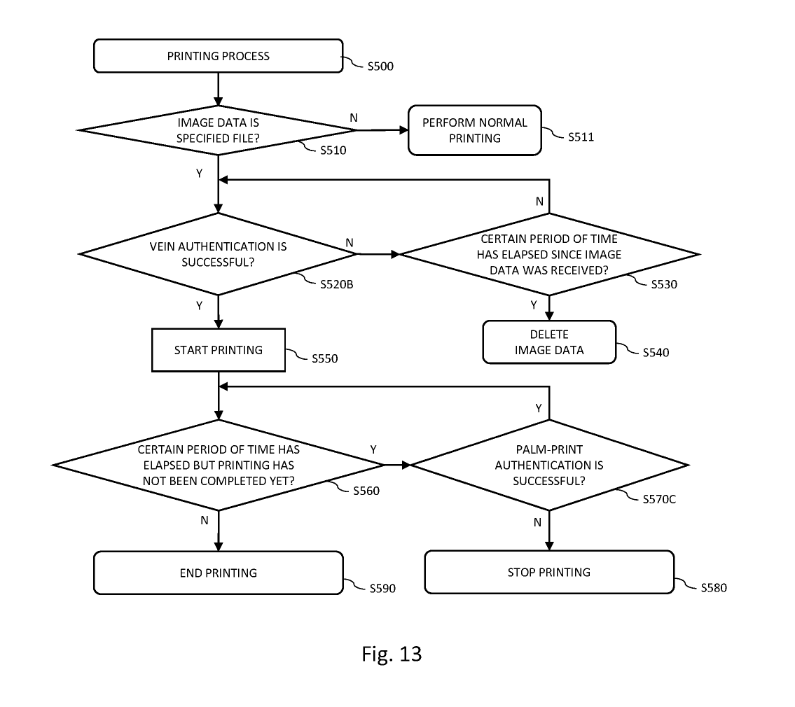

Next, an embodiment 7 of the present invention will be described with reference to FIGS. 12 and 13. In this embodiment, biometric information used for the authentication is different from that of the embodiment 5, and therefore S520B and S570C replace S520A and S570B, respectively. In addition, as shown in FIG. 12, a biometric information detector 160 is provided instead of the fingerprint detector 150 of the printing apparatus 10 of the embodiment 5. In the following, a specific description will be given mainly of differences from the embodiment 5, and functions and processes similar to those of the embodiment 5 are not described.

The printing apparatus 10 provided in a printer system according to this embodiment includes a CPU 100, a communication I/F 110, a memory 120, a printing unit 140, and a biometric information detector 160.

(Biometric Information Detector 160)

The biometric information detector 160 detects biometric information of a user, and outputs the detected information to the CPU 100. To be more specific, the biometric information detector 160 photographs veins of a particular finger and a palm print of a hand that a user places on the biometric information detector 160, and transmits obtained image information to the CPU 100.

(CPU 100)

The CPU 100 identifies user information based on the image information of the veins and palm print received from the biometric information detector 160, and compares the identified user information against user identification information associated with image data of a specified file stored in the memory 120, to thereby execute a vein authentication and a palm-print authentication.

(S520B)

In S520B, the printing apparatus 10 (CPU 100) executes the vein authentication. More specifically, a display that prompts the vein authentication is presented on a screen of the PC 20 in response to a command given from the printing apparatus 10, and then the CPU 100 determines by comparison whether or not user information contained in vein authentication information corresponding to veins of a placed finger that is detected by the biometric information detector 160 is coincident with user identification information associated with a confidential file. A process subsequent to this is the same as described in the embodiment 5.

(S570C)

In S570C, the CPU 100 executes the palm-print authentication. More specifically, the biometric information detector 160 determines by comparison whether or not user information contained in palm-print authentication information corresponding to a palm print of a placed hand is coincident with user identification information associated with a confidential file. A process subsequent to this is the same as described in the embodiment 5.

As thus far described, the image forming apparatus (printing apparatus 10) of this embodiment performs the vein authentication and the palm-print authentication. The vein authentication, which provides a high-accuracy authentication, is performed at the start of printing, and the palm-print authentication, which provides a less accuracy, is performed at intermittent timings. This can avoid a situation where printing is stopped due to an accidental authentication failure at a time of determining whether or not to continue the image formation.

### 8. Embodiment 8

Next, an embodiment 8 of the present invention will be described. This embodiment is different from the embodiment 5 in that the partial fingerprint authentication is replaced by at least one of the partial fingerprint authentication and a fingerprint authentication using another finger. In the following, a specific description will be given of differences from the embodiment 5, and functions and processes similar to those of the embodiment 5 are not described.

(S570B)

In a process of S570B of this embodiment, the CPU 100 executes the partial fingerprint authentication or a fingerprint authentication using another finger. More specifically, the CPU 100 executes the partial fingerprint authentication, and if the partial fingerprint authentication is failed, executes an authentication of an entire fingerprint of another finger of the same user. The CPU 100 compares information of an entire fingerprint associated with user information that is identical with user identification information associated with image data of a currently printed confidential file, against the fingerprint detected by the fingerprint detector 150. If the comparison results in determination that the user identification information associated with the image data of the currently printed confidential file is identical with user information contained in fingerprint authentication information corresponding to the fingerprint detected by the fingerprint detector 150, the CPU 100 determines that the authentication is successful, and continues the printing.

Executing the above-described process allows the user to change a finger used for the authentication in the middle of printing. Accordingly, the burden imposed on the user when the user continues the authentication can be reduced.

### 9. Embodiment 9

Next, an embodiment 9 of the present invention will be described. This embodiment is different from the embodiment 1 in that, if the verification with the IC card is failed, a verification of a password is performed, and if the password is successfully verified, printing is started. In addition, the printing apparatus 10 includes an input unit that enables a user to input a password. In the following, a specific description will be given of differences from the embodiment 1, and functions and processes similar to those of the embodiment 1 are not described.

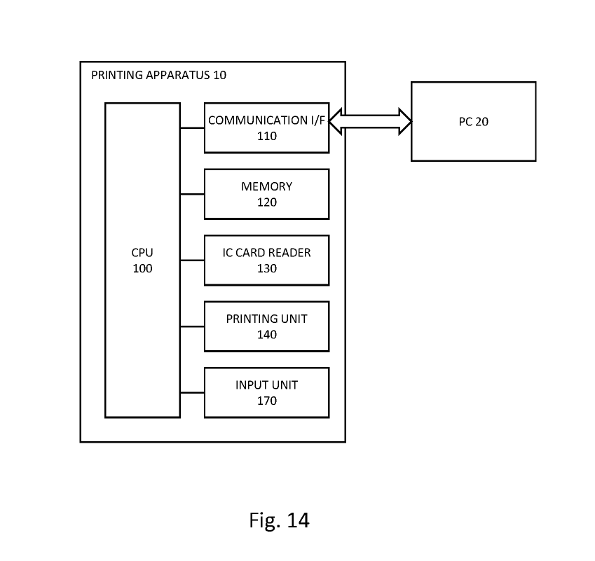

FIG. 14 shows a configuration of a printer system according to this embodiment. As shown in FIG. 14, the printer system includes a printing apparatus 10 and a PC 20.

(Printing Apparatus 10) The printing apparatus 10 includes a CPU 100, a communication I/F (communication interface) 110, a memory 120, an IC card reader 130, a printing unit 140, and an input unit 170.

(Input Unit 170)

The input unit 170 detects an input operation made by a user, and obtains input information based on the detected operation. The obtained input information is outputted to the CPU 100. The input unit 170 includes a keyboard, a touch panel, or the like.

(Memory 120)

The memory 120 stores, as user identification information associated with image data, a password used for the start of printing.

(CPU 100)

The CPU 100 executes a password authentication by verifying a password contained in user identification information associated with image data of a specified file, which is stored in the memory 120, against input information inputted through the input unit 170.

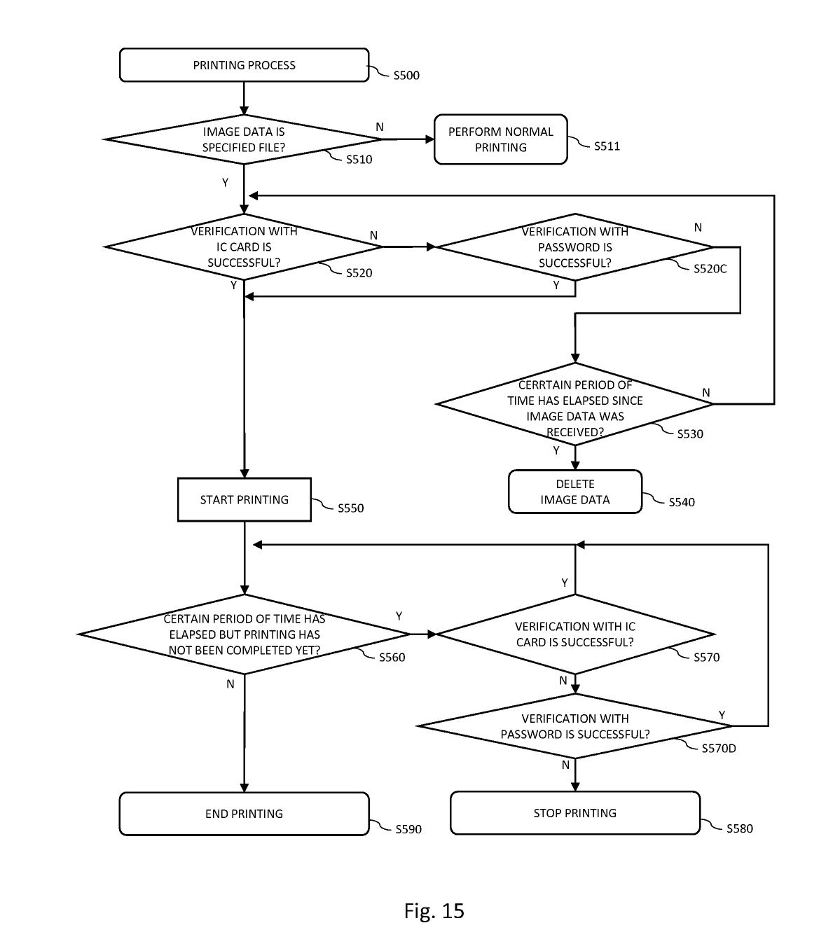

Next, a specific example of the printing process will be described with reference to FIG. 15. In the following, descriptions already given in the embodiment 1 are omitted, and processes of S520C and S570D, which are differences from the embodiment 1, will be described.

(S520C)

If a verification of user identification information associated with image data with use of an IC card is failed (S520:N), the CPU 100 notifies the user of the failure in the verification and prompts a password verification prior to executing the process of S530. After the user operates the input unit 170 to input a password, the CPU 100 verifies the inputted password against a password contained in the user identification information associated with the image data for which the verification of the user identification information with use of the IC card has been failed (S520C). If the inputted password is coincident with the password contained in the user identification information (S520C:Y), the process goes to S550 to start printing. If the inputted password is different from the password contained in the user identification information (S520C:N), the process goes to S530.

(S570D)

If, after the printing is started, a certain period of time has elapsed but the printing has not been completed yet (S560), a verification with the IC card is performed. If the verification of the user identification information associated with the image data with use of the IC card is failed (S570:N), the CPU 100 notifies the user of the failure in the verification and prompts a password verification prior to executing the process S580 of stopping the printing. After the user operates the input unit 170 to input a password, the CPU 100 verifies the inputted password against a password contained in the user identification information associated with the image data for which the verification of the user identification information with use of the IC card has been failed (S570D). If the inputted password is coincident with the password contained in the user identification information (S570D:Y), the printing is continued. If the inputted password is different from the password contained in the user identification information (S570D:N), the process goes to S580 to stop the printing.

The above-described process enables the printing to be performed even when the verification of the identification information is failed due to, for example, damage of the IC card, because a verification with use of another identification information is provided.

The password verification described above may be implemented by another means. For example, it may be acceptable that the user inputs his/her employee number through the input unit 170 so that a verification based on the employee number is performed to start or continue the printing. Instead of the verification with the IC card, a verification with biometric information such as a fingerprint may be adoptable, too.

### 10. Embodiment 10

Next, an embodiment 10 of the present invention will be described. This embodiment is different from the embodiment 1 in that the printing apparatus 10 further includes a display unit 180 and that the printing apparatus 10 has a function of displaying a time to completion of the current printing on the display unit 180. In the following, a specific description will be given mainly of the differences, and functions and processes similar to those of the embodiment 1 are not described.

(Display Unit 180)

The display unit 180 includes an LCD (liquid crystal display), an organic EL display, or the like, and is controlled by the CPU 100 to display a time to completion of the current printing.

If printing of another image data is in execution at the time of the verification with the IC card (S520), the CPU 100 causes the display unit 180 to display a time to completion of the printing of said another image data. At this time, the CPU 100 calculates the time to completion of the printing by, for example, comparing the total data size of the currently printed image data against the data size of the already printed part of the image data. For calculation of the time to completion of printing, various existing methods are adoptable.

The image forming apparatus having the above-described configuration enables the user to recognize, for example, a time to completion of printing of the currently printed data at the time of the verification of the identification information. This can enhance convenience to the user.

### 11. Supplementary Remarks

Hereinbefore, specific descriptions of the embodiments of the present invention have been given. These embodiments are merely illustrative. The scope of the present invention is not restricted to the illustrative embodiments. The present invention should be construed as widely as those skilled in the art can appreciate.

The embodiments 1 to 10 can be implemented in combination. For example, a combination of the embodiments 2 and 3 achieves an image forming apparatus having a function of prioritizing the printing order of the specified file and a function of requiring the user to once put the IC card off for re-verification in a case of printing specified files in succession. A combination of the embodiments 6 and 7 can provide an image forming apparatus enabling authentications based on vein information and palm-print information and having a function of changing the printing orders of confidential files.

Although the embodiments 1 to 4 use the IC card to verify the user identification information, use of the IC card is not essential. Any information may be adoptable as long as the information is recorded on a medium that can be read by using a predetermined read function. Although the embodiments illustrate as an example a contactless IC card and an IC card reader that is able to read an IC card located near the IC card reader, a medium used for the verification of the user identification information may be of either contact type or contactless type.

In the above-described embodiments, the condition for succeeding in the verification is that the user identification information is identical, but the condition may be eased. That is, the success may be established not only when the user identification information is completely identical but also when a predetermined easier condition is satisfied. For example, an adoptable method is determining whether or not the verification of the user identification information is successful based on whether or not the user identification information is included in a user group that is pre-registered in the printing apparatus 10. In such a case, the file type may include disclosure range information as information indicating a user group permitted to access the image data. The file type may be called specific disclosure information.

Although the above-described embodiments illustrate the specified file and the normal file as an example, the process performed on the specified file may be applied to all files. Alternatively, the level of the specified file may differ depending on the confidentiality. In such a case, the level of the verification of the user identification information may differ accordingly. For example, it may be conceivable that the verification of the user identification information performed upon each elapse of a certain period of time as illustrated in S560 and S570 is applied to a highly confidential specified file having a high level of confidentiality while the verification of the user identification information performed upon each elapse of a certain period of time as illustrated in S560 and S570 is omitted for a moderately confidential specified file having a middle level of confidentiality. In the embodiment 3, moreover, the re-verification with use of the IC card performed in S600 and subsequent steps may be required only for a highly confidential specified file. In the embodiment 4, furthermore, the printing by interruption executed in S521B to S521D may be permitted only for a highly confidential specified file. In another possible example, the vein authentication is performed at the start of printing a confidential file having a high confidentiality while the fingerprint authentication is performed at the start of printing a confidential file having a middle confidentiality.

It may be acceptable to provide an alert to the PC 20 before printing of the specified file is stopped in S580, and then stop the printing if a certain period of time has elapsed but the verification with the IC card has not been successful yet.

Although the fingerprint authentication is performed in the embodiments 5 and 6 while the vein authentication and palm-print authentication are performed in the embodiment 7, such authentications using biometric information may be replaced by other authentications. For example, an authentication using the iris of an eye, a voice print, or a face image may be adoptable. It is however preferable that the authentication performed at the start of printing has a higher accuracy (a higher degree of difficulty) than the authentication performed to determine whether or not to continue the printing.

It may be acceptable to provide a plurality of biometric authentication methods, and determine that the biometric authentication for continuing the printing is successful if one of the plurality of biometric authentications is successful.

In the above-described embodiments, the display that prompts the authentication is presented on the PC 20 (see S520A, S520B), but the display may be presented on the display unit of the printing apparatus 10.

The present invention is suitably applied as an image forming apparatus having a function of preventing a highly confidential document or the like from remaining uncollected.

What is claimed is:

1. An image forming apparatus comprising:
a storage that stores data, first identification information, and specified disclosure information, the first identification information and the specified disclosure information being associated with the data;
a reader that reads second identification information;
a controller that compares the first identification information with the second identification information based on the specified disclosure information; and
an image forming unit that forms an image based on a result of the comparison.

2. The image forming apparatus according to claim 1, wherein
the storage stores an image-forming order that is according to the order in which the data is received,
the controller changes the image-forming order based on the specified disclosure information,
the image forming unit forms an image based on the changed image-forming order.

3. The image forming apparatus according to claim 2, wherein
upon succeeding in the comparison, the controller raises the image-forming order of the data.

4. The image forming apparatus according to claim 3, wherein
in a case where image formation of another data is in execution, the controller raises the image-forming order of the data so as to cause image formation of the data to be performed next to the image formation of said another data.

5. The image forming apparatus according to claim 4,
further comprising a display unit that displays a time to completion of the image formation of said another data during the image formation of said another data.

6. The image forming apparatus according to claim 3, wherein
in a case where there is data associated with first identification information that is identical with the first identification information of the data, the controller collectively raises image-forming orders of the plurality of data associated with the same first identification information.

7. The image forming apparatus according to claim 2, wherein
upon failing in the comparison, the controller prioritizes image formation of another data over image formation of the data.

8. The image forming apparatus according to claim 7, wherein
upon failing in the comparison and not yet succeeding in the comparison after a predetermined period of time elapses since the data is received, the controller deletes the data stored in the storage.

9. The image forming apparatus according to claim 8,
further comprising an input unit that obtains fourth identification information based on an input operation detected, wherein
the storage further stores third identification information associated with the data,
upon failing in the comparison and succeeding in a comparison of the third identification information with the fourth identification information, the controller considers the comparison as successful and executes the same processing as executed upon succeeding in the comparison.

10. The image forming apparatus according to claim 2, wherein
the controller prioritizes image formation of another data over image formation of the data until the reader reads the second identification information.

11. The image forming apparatus according to claim 10, wherein
in a case where the second identification information is not yet read by the reader after a predetermined period of time elapses since the data is received, the controller deletes the data stored in the storage.

12. The image forming apparatus according to claim 11,
further comprising an input unit that obtains fourth identification information based on an input operation detected, wherein
the storage further stores third identification information associated with the data,
in a case where the second identification information is not read by the reader and a comparison of the third identification information with the fourth identification information is successful, the controller considers the comparison as successful and executes the same processing as executed upon succeeding in the comparison.

13. The image forming apparatus according to claim 1, wherein
in a case where, after image formation of the data is started, a predetermined period of time elapses but the image formation is continued, the controller re-executes the comparison of the first identification information with the second identification information.

14. The image forming apparatus according to claim 1, wherein
the first identification information and the second identification information are biometric information.

15. The image forming apparatus according to claim 1, wherein
the first identification information and the second identification information are fingerprint information.
